(19) United States
(12) Patent Application Publication
(10) Pub. No.: US 2026/0141462 A1
(43) Pub. Date: May 21, 2026

(54) PHYSICS-INSPIRED MACHINE LEARNING FOR RELIABLE PRODUCTION FORECAST IN UNCONVENTIONAL RESERVOIRS

(71) Applicant: ConocoPhillips Company, Houston, TX (US)

(72) Inventors: Hui Zhou, Houston, TX (US); Mazaruny Rincones, Houston, TX (US); Lucybel Montilla, Houston, TX (US); Olakunle A. Orogbemi, Houston, TX (US)

(21) Appl. No.: 19/392,682

(22) Filed: Nov. 18, 2025

Related U.S. Application Data
(60) Provisional application No. 63/721,720, filed on Nov. 18, 2024.

(51) Int. Cl. G06Q 50/02; G06Q 10/0631

(52) U.S. Cl. CPC G06Q 50/02; G06Q 10/06315

(57) ABSTRACT

Implementations described and claimed herein provide systems and methods for an innovative machine learning-driven approach, rooted in the fundamental physics of flow within fractured tight reservoirs for production forecasting of unconventional reservoirs. A first component of the method is to automatically analyze production data and generate characteristic attributes for linear flow and boundary-dominated flow. Following this, a Markov chain Monte Carlo process is utilized to integrate actual production data with flow regime analysis, resulting in probabilistic multi-segment decline models for production forecasting with uncertainty ranges and confidence estimation. Further, the method may include a two-step machine learning model to predict future planned wells. The two-step machine learning model may include a first aspect to generate predicted flow regime characteristics for one or more unconventional reservoirs and a second aspect to utilize the flow regime characteristics to generate the production forecast for the reservoirs.

### CROSS-REFERENCE TO RELATED APPLICATIONS

The present application claims priority to U.S. Provisional Patent Application No. 63/721,720 filed on Nov. 18, 2024, which is incorporated by reference in its entirety herein.

### FIELD

Aspects of the present disclosure relate generally to systems and methods for production forecasting in unconventional reservoirs and, more particularly, to an innovative machine learning-driven approach to production forecasting in unconventional reservoirs, rooted in the fundamental physics of flow within fractured tight reservoirs.

### BACKGROUND

Production forecasting for unconventional reservoirs is a pivotal element in the planning and development strategies of oil and gas operations. Given the complex nature of unconventional resources, accurate forecasting is crucial for optimizing resource recovery and economic returns. Unconventional reservoirs present unique challenges for production forecasting due to their heterogeneity and the significant impact of engineering practices on production performance, such as hydraulic fracturing, well spacing, and well sequencing.

Empirical methods in production forecasting, such as decline curve analysis (DCA), have been the cornerstone of reservoir engineering for decades. These methods rely on fitting historical production data, using various mathematical models to extrapolate future performance. Further, with the advancement of machine learning, the application of such techniques for production forecasting offers a promising, automated alternative. Machine learning (ML) models, such as linear and polynomial regression, support vector regression, decision trees, and artificial neural networks (ANN), can learn from data without explicit programming. These models can uncover complex patterns and relationships that traditional models may not readily reveal due to their intricacy. However, the performance of state-of-the-art deep learning algorithms does not significantly surpass traditional statistical methods, like exponential smoothing and autoregressive integrated moving average in terms of accuracy, effectiveness, or efficiency. It is also important to consider the ‘black box’ nature of ML algorithms. This characteristic often makes it challenging, if not impossible, to interpret the forecasting results and to understand the main drivers of production performance.

It is with these observations in mind, among others, that various aspects of the present disclosure were conceived and developed.

### SUMMARY

Implementations described and claimed herein address the foregoing problems by providing systems and methods for an innovative machine learning-driven approach, rooted in the fundamental physics of flow within fractured tight reservoirs for production forecasting of unconventional reservoirs. The production optimization may include the operations of receiving, using a processing device and from a plurality of databases, production data corresponding to one or more wells of the field, generating, based on the received field data, a production forecast for the one or more wells of the field, wherein the production forecast is an output of a two-step machine learning process comprising a first machine learning process to predict, based on the received field data, predicted flow regime characteristics of the one or more wells of the field and a second machine learning process to receive the predicted flow regime characteristics as inputs and output the production forecast, and generating, based on production forecast, a well development sequence for the field.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however the emphasis instead is being placed on illustrating the principles of the inventive concepts. Also, in the drawings the like reference characters may refer to the same parts or similar throughout the different views. It is intended that the embodiments and figures disclosed herein are to be considered illustrative rather than limiting.

FIG. 1 shows an example network environment that may implement various systems and methods discussed herein.

FIG. 2 shows an example block diagram of a development optimization platform for well sequencing and unconventional well management.

FIG. 3 shows a simplified reservoir/fracture system for multi-fractured horizontal wells in both a linear flow regime and a boundary dominated flow regime.

FIG. 4 illustrates linear flow regime identification and characterization from a log-log plot and specialized sqrt (time) plot.

FIG. 5 illustrates a boundary dominated flow regime identification and characterization from a log-log plot perspective and a specialized material balance plot perspective.

FIG. 6 illustrates a neural network architecture to predict the selected physical characteristics of the flow regimes.

FIG. 7 illustrates a machine learning model to predict decline curve analysis parameters using these physical characteristics as features.

FIG. 8 illustrates an integrated machine learning workflow to form an encoder-decoder type of architecture in neural networks.

FIG. 9 illustrates an automated flow regime analysis obtained from a physics-based machine learning model.

FIG. 10 illustrates automated production forecast for oil rate and oil cumulative production.

FIG. 11 illustrates example operations for utilizing a development optimization platform for production forecasting in unconventional reservoirs.

FIG. 12 shows an example computing system that may implement various systems and methods discussed herein.

### DETAILED DESCRIPTION

Aspects of the present disclosure involve systems and methods for an innovative machine learning-driven approach, rooted in the fundamental physics of flow within fractured tight reservoirs for production forecasting of unconventional reservoirs. The systems are constructed upon analytical solutions for multi-stage fractured shale reservoirs, assuming uniform bi-wing planar fractures and reservoir homogeneity. This simplification represents an asymptotic solution to unconventional wells and aligns with characteristic plots of field production. A first component of the method is to automatically analyze production data and generate characteristic attributes for linear flow and boundary-dominated flow. Following this, a Markov chain Monte Carlo process is utilized to integrate actual production data with flow regime analysis, resulting in probabilistic multi-segment decline models for production forecasting with uncertainty ranges and confidence estimation. Building on these characteristics and production forecasts derived from existing producing wells, the method includes a two-step machine learning model to predict future planned wells. The two-step machine learning model may include a first aspect to generate predicted flow regime characteristics for one or more unconventional reservoirs and a second aspect to utilize the flow regime characteristics to generate the production forecast for the reservoirs. In some implementations, both aspects of the machine learning model may be integrated into a single model, which would form an encoder-decoder type of architecture in neural networks, to enhance the machine learning model's overall performance while reducing the time needed to obtain the model outputs.

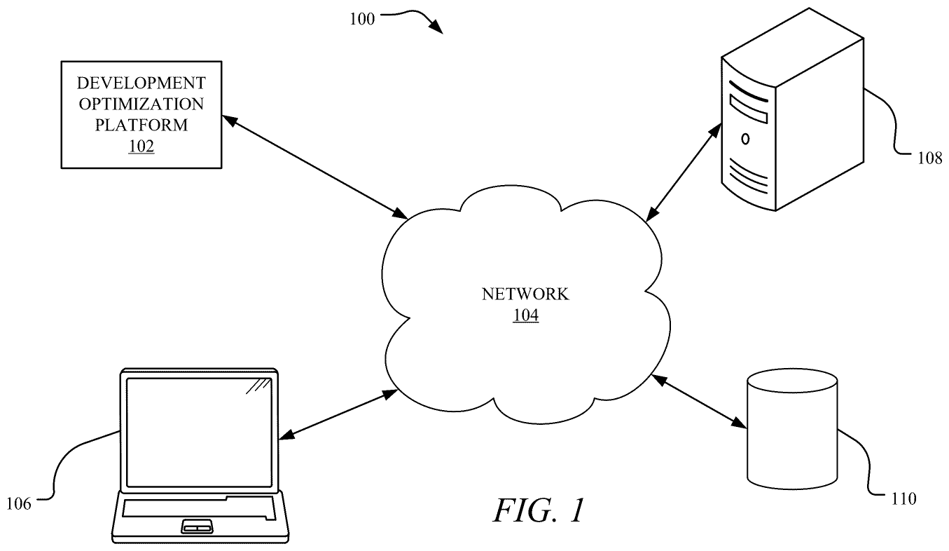

To begin a detailed discussion of an example production forecast and reservoir management system 100, reference is made to FIG. 1. In particular, FIG. 1 depicts a network 104 is used by one or more computing or data storage devices for implementing the systems and methods for a development optimization platform 102 for reservoir management of unconventional reservoirs. In one implementation, various components of the development optimization platform 102, one or more user devices 106, one or more databases 110, and/or other network components or computing devices described herein are communicatively connected to the network 104. Examples of the user devices 106 include a terminal, personal computer, a smart-phone, a tablet, a mobile computer, a workstation, and/or the like.

A server 108 may, in some instances, host the system. In one implementation, the server 108 also hosts a website or an application that users may visit to access the system 100, including the production forecast platform 102. The server 108 may be one single server, a plurality of servers with each such server being a physical server or a virtual machine, or a collection of both physical servers and virtual machines. In another implementation, a cloud hosts one or more components of the system. The development optimization platform 102, the user devices 106, the server 108, and other resources connected to the network 104 may access one or more additional servers for access to one or more websites, applications, web services interfaces, etc. that are used for reservoir management.

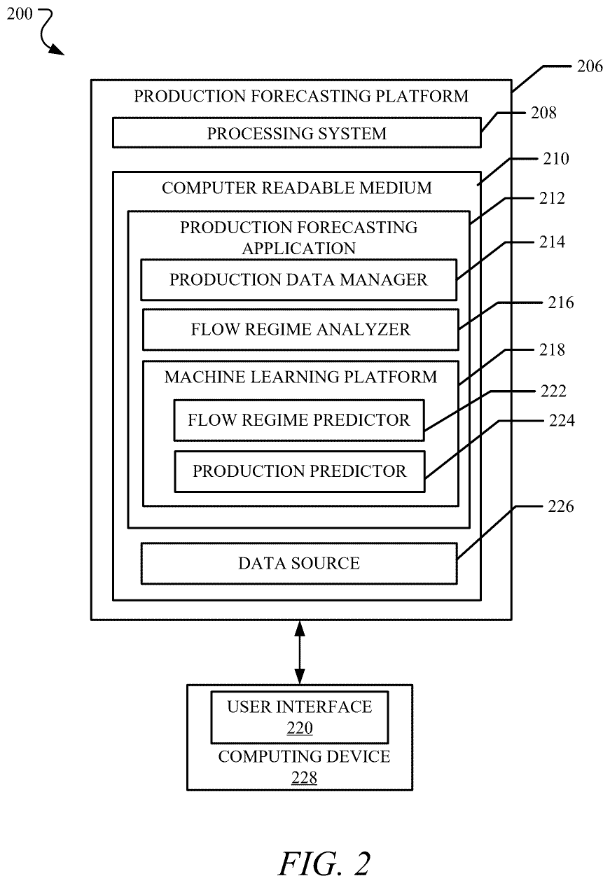

FIG. 2 shows an example block diagram of a development optimization system 200 for forecasting production and general unconventional reservoir management. In general, the system 200 may include a forecasting production platform 206. In one implementation, the forecasting production platform 206 may be a part of the development optimization platform 102 of FIG. 1. As shown in FIG. 2, the forecasting production platform 206 may be in communication with a computing device 228 providing a user interface 220. As explained in more detail below, the forecasting production platform 206 may be accessible to various users for generating production forecasts and other management processes of unconventional reservoirs. In some instances, access to the forecasting production platform 206 may occur through the user interface 220 executed on the computing device 228.

The forecasting production platform 206 may include a forecasting production application 212 executed to perform one or more of the operations described herein. The forecasting production application 212 may be stored in a computer readable media 210 (e.g., memory) and executed on a processing system 208 of the forecasting production platform 206 or other type of computing system, such as that described below. For example, the forecasting production application 212 may include instructions that may be executed in an operating system environment, such as a Microsoft Windows™ operating system, a Linux operating system, or a UNIX operating system environment. By way of example and not limitation, non-transitory computer readable medium 210 comprises computer storage media, such as non-transient storage memory, volatile media, nonvolatile media, removable media, and/or non-removable media implemented in a method or technology for storage of information, such as computer readable instructions, data structures, program modules, or other data.

The forecasting production application 212 may also utilize a data source 226 of the computer readable media 210 for storage of data and information associated with the forecasting production platform 206. For example, the forecasting production application 212 may store received data or inputs, processing details, and/or output information, and the like. As described in more detail below, the generated production forecasts and/or other reservoir management data may be stored and accessed via the user interface 220.

Reliable production forecasting in unconventional reservoirs is fundamentally dependent on a deep understanding of the physics that governs subsurface flow dynamics. For unconventional shale reservoirs, for example, analyzing flow regimes, including linear and boundary-dominated flow, may provide pivotal insights for production forecasts. Traditional rate transient analysis methods, however, rely heavily on manual processes, introducing a degree of subjectivity and potential bias into the results. The forecasting production application 212 of FIG. 2 may include several components or aspects to address the challenges and incorporate such considerations in production forecasting and reservoir management. For example, the forecasting production application 212 may include machine learning-driven algorithms rooted in the fundamental physics of flow within fractured tight reservoirs. These algorithms may enhance efficiency, flexibility, and automation through machine learning to boost the reliability and insights in production forecasts by leveraging a robust physics-based foundation.

In one implementation, an analytical, asymptotic solution is provided for unconventional reservoirs that aligns with characteristic plots of field production. To facilitate the solution, the forecasting production application 212 may include a production data manager 214 to automatically analyze production data and generate characteristic attributes for linear flow and boundary-dominated flow. The forecasting production application 212 may also include a flow regime analyzer 216 to integrate actual production data with flow regime analysis through a Markov chain Monte Carlo process, resulting in probabilistic multi-segment decline models for production forecasting with uncertainty ranges and confidence estimation. Further, a machine learning platform 218 may be included in the forecasting production application 212 to build on these characteristics and production forecasts derived from existing producing wells to predict future planned wells. In particular, the machine learning platform 218 may incorporate a flow regime predictor 222 and/or a production predictor 224, either of which may incorporate machine learning techniques or algorithms to output the respective predictions. The operations of each of these components of the machine learning platform 218 is discussed in greater detail below.

In more particular detail, the production forecasting platform 206 may utilize one or more machine learning algorithms 218 that consider the key flow regimes (or physics) of fluid flow through multi-fractured horizontal wells (MFHW) in unconventional reservoirs. These algorithms may utilize conceptual well performance principles established for rate transient analysis (RTA) and pressure transient analysis (PTA) to generate key characteristics, such as the timing of flow regimes and essential physical quantities within each regime. The algorithms may also leverage the connection between flow regimes and decline curve analysis (DCA) to establish a reliable production forecast for existing wells. Given sufficient data for a representative number of wells in the boundary-dominated flow regime, a machine learning model may be trained to directly forecast physical characteristics and DCA parameters, thereby predicting production for future wells.

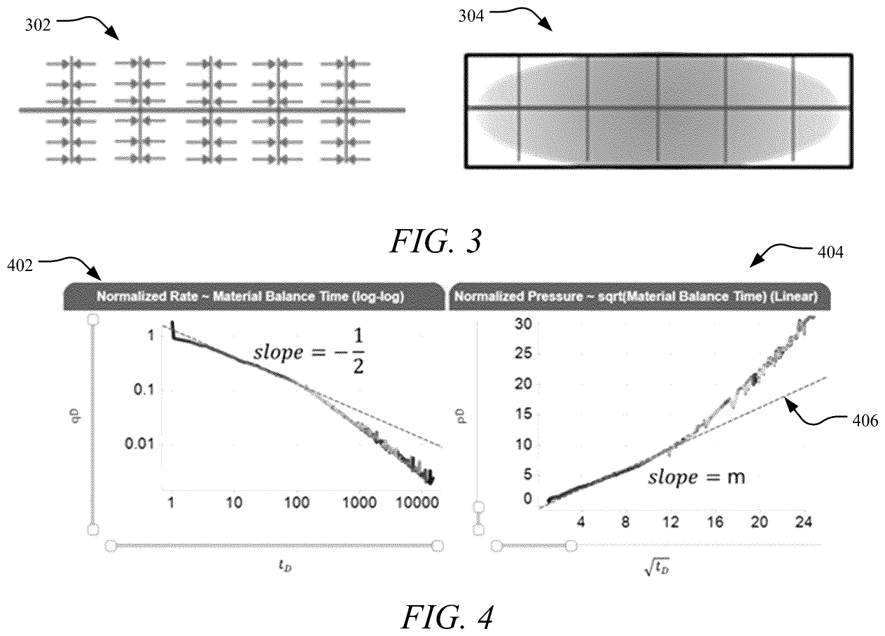

The physics underlying fluid flow in the reservoir/well system of shale reservoirs and multi-fractured horizontal wells (MFHW) is relatively complex. As horizontal wells become increasingly longer—often exceeding 5,000 ft—the heterogeneity of reservoir and geomechanical properties becomes more pronounced. This complexity is further compounded by massive multistage stimulation, which challenges many attempts to characterize the fractured shale system's geometry and physical properties, both of which are used for accurate production forecasting. Thus, rather than relying on a full physics-based solution, which would necessitate detailed reservoir characterization and the solving of partial differential equations using numerical reservoir simulations, the machine learning algorithms described herein rely on a simplified physical system, one assuming a homogeneous reservoir, uniform planar fractures, and slightly compressible fluids. For example, FIG. 3 illustrates a simplified reservoir/fracture system for MFHW in both a linear flow regime (illustrated in diagram 302) and a boundary dominated flow regime (illustrated in diagram 304).

These simplifying assumptions may be considered a reasonable asymptotic approximation for MFHW in shale reservoirs. From a practical standpoint, the linear flow 302 and boundary-dominated flow 304 regimes are the most prevalent and observable in most shale reservoirs. The linear flow (LF) regime 302 refers to the state of flow in the reservoir/fracture system that it is dominated by flow from the reservoir into the fracture system. In other words, the cross flow in the direction parallel to the fracture plane is negligible in comparison. Under the assumption of a planar fracture, the flow equation becomes one-dimensional, and an analytic solution can then be derived under either constant rate or constant pressure condition. The analytical solution can be generalized to variable rate/pressure condition of normalized rate q_{D} and material balance time (t_{D}), as shown in Equations (1) and (2) where q is flow rate of a fluid phase, pₚᵢ and p_{wf} are initial pressure (or pseudo pressure to account for fluid compressibility) and flowing pressure respectively, and Q is the cumulative production.

$${q}_{D} = \frac{q}{{p}_{pi} - {p}_{wf}} \qquad ( 1 )$$

$${t}_{D} = \frac{Q ( t )}{q ( t )} \qquad ( 2 )$$

The log-log plot of q_{D} versus t_{D} can then be developed to identify flow regimes. A slope of ½ is the signature of linear flow regimes. A specialized plot of

$$\frac{1}{{q}_{D}}$$

versus \sqrt{t_{D}} in linear scale can also be developed in conjunction with the log-log plot to further confirm the linear flow regime where a linear trend is expected to identify the linear flow regime, as shown in the graphs of FIG. 4 for an example well. In particular, FIG. 4 illustrates a linear flow regime identification and characterization from a log-log plot 402 and specialized sqrt (time) plot 404.

Moreover, the reciprocal of the slope of the linear line m 406 is shown to be proportional to A\sqrt{k} which is a reservoir and fracture quantity also known as linear flow parameter (LFP). Here, A is the total fracture area and k is the reservoir permeability through which fluid flows into fractures. The full equation is shown below by Equation (3) where T,φ,μ,cₜ is reservoir temperature, porosity, fluid viscosity and total compressibility, respectively.

$$A \sqrt{k} = \frac{630.8 T}{m \sqrt{ϕ μ {c}_{t}}} \qquad ( 3 )$$

In some instances, the noise in the data may make the identification of linear line m 406 not only tedious to manually identify, but also bring subjectivity and bias up the practitioner. In this manner, a machine learning tool that could systematically identify the flow regime and calculate A\sqrt{k} is an improvement over previous methods using linear flow analysis.

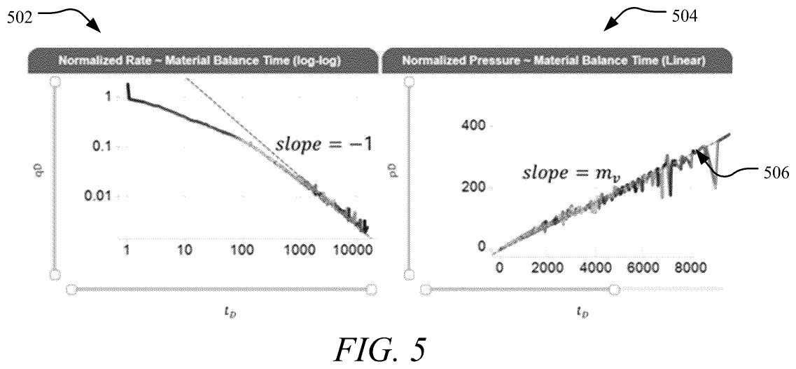

The boundary-dominated flow (BDF) regime 304 occurs when pressure depletion extends across the entire reservoir, bounded by no-flow boundaries. This concept may apply to both conventional and unconventional reservoirs. In shale reservoirs with MFHW, such boundaries might be the edge of the stimulated rock volume (SRV) or the borders between adjacent well drainage areas, forming a no-flow boundary. FIG. 5 illustrates a boundary dominated flow regime identification and characterization from a log-log plot 502 perspective and a specialized material balance plot 504 perspective. The log-log plot 502, as above, is useful for identifying BDF where the signature is a slope of −1. The BDF can also be identified and characterized by a plot of 1/q_{D} versus t_{D} in linear scales (i.e., material balance plot) by a linear trend line in plot 504. The slope of the line my 506 can be used to calculate the drainage volume V_{d} as in Equation (4). Note the noise of data is even more prominent in BDF as production rate declines.

$${V}_{d} = \frac{0.2339 B}{{m}_{ν} ϕ {c}_{t}} \qquad ( 4 )$$

For wells that have been producing long enough to experience boundary-dominated flow (BDF), one forecasting approach includes analyzing flow regimes as summarized previously, and then forecasting using decline curve analysis (DCA). However, this seemingly straightforward workflow faces challenges that can result in unreliable forecasts. For example, the presence of noise in the data, particularly in pressure and flow rates, may create uncertainty in the analysis. As mentioned earlier, noise can significantly obscure the differentiation between flow regimes, complicating the identification process. This issue is exacerbated when using material balance time, which does not always increase monotonically with actual time. To address these challenges, one or more machine learning techniques may be developed and employed to automate the identification and characterization of flow regimes, thereby enhancing efficiency and reducing the potential for human bias inherent in traditional manual rate transient analysis (RTA) workflows.

As illustrated in FIGS. 4 and 5, one output of a machine learning model is to identify the linear signature from both the log-log plot 402, 502 and the specialized plot 404, 504 for each flow regime, such as the \sqrt{t} plot for LF and the material balance plot for BDF. In one instance, the linear regression model may be utilized. However, linear regression is typically a supervised learning method that uses human-generated training targets. This challenge can be overcome by coupling the linear regression with an optimization algorithm that aims to minimize the regression error compared to the expected characteristic line for each flow regime by finding the optimal time window. This process may be fully automated by the production forecasting platform 206, requiring no human intervention. The algorithm may also generate a smoothed numerical derivative based on the derivative of the production integral from the log-log plot. Each point of the log-log plot 402, 502 and the specialized plot 404, 504 may be consistently color-coded by algorithm to aid in quality control and to gain insights from the data and automated computations.

In some instances, uncertainty may exist for production forecasting due to noise in production data and the simplified assumptions in DCA models. One method to incorporate uncertainty into the production forecast is the Markov Chain Monte Carlo (MCMC) method. The goal of MCMC in machine learning algorithms of the production forecasting platform 206 is to generate a posterior distribution as given by the Bayesian theorem or Equation (5) below, where θ represents the model parameters (i.e., DCA parameters), D represents the data, P(θ) is the prior distribution, P(D|θ) is the likelihood function and P(θ|D) is the posterior distribution of a model θ given data D is observed. The prior distribution represents the knowledge of the model based on our historical information. The likelihood function quantifies how likely a particular set of model parameters could explain the observed data, or in other words, how closely the model parameters fit the data. In this implementation, P(D) may normalize the probability given by the numerator under the requirement to sum the full distribution to 1. The MCMC process is therefore to create a Markov chain that converges to the posterior distribution given by Equation (5).

$$P ( θ \vert D ) = \frac{P ( D \vert θ ) P ( θ )}{P ( D )} \qquad ( 5 )$$

In the proposed workflow of the machine learning algorithm provides for a two-segment DCA model to forecast production decline corresponding to the transient and transitional flow and boundary dominated flow. The onset of the second segment t₂ is the start of the BDF regime with uncertainty taken into account based on the automated calculation. The distribution of b value for the two segments, b and b₂ includes b₁ in the range of 1 to 2 and b₂ in the range of 0.6 to 1, with the distribution of initial production rate qᵢ and decline rate Dᵢ comes measurements for each basin. In general, the result may not be very sensitive to the distribution for Dᵢ unless it is overly constrained.

With enough producing wells, the physics-informed machine learning models may be refined or taught to project future well performance for more accuracy based on measurements and performances of existing wells. In particular, the models can incorporate specific development variables, such as completion techniques, spacing, and sequencing designs. Generally, a dataset that includes at least a hundred wells in each geologically comparable region, ideally covering a range of development strategies, may be used to train the models.

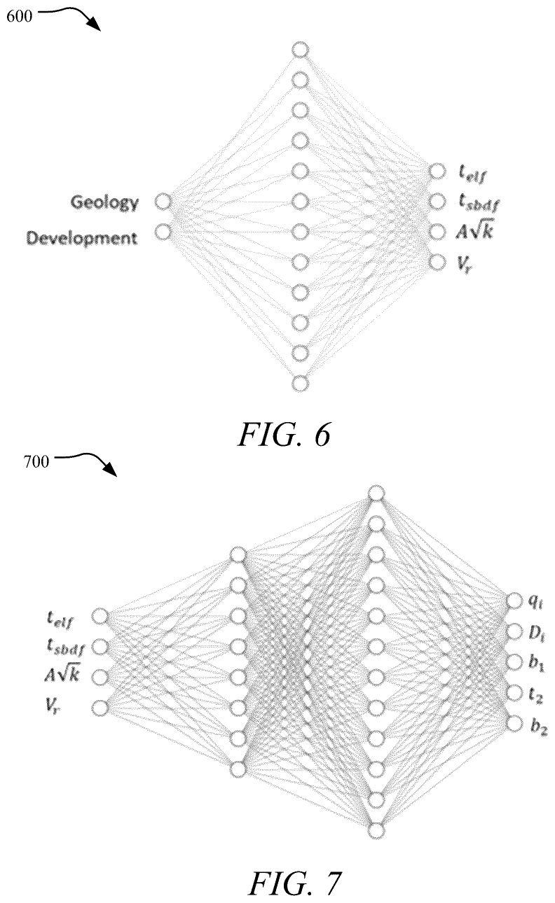

Through the production forecasting platform 206, a fully automated, two-step machine learning workflow that is guided by physics and engineering intuition is provided. The training data for the algorithm may come from actual measurements or be automatically generated by auxiliary machine learning models. In a first step, a machine learning model is generated to predict the flow regimes and their characteristics. In particular, the first step may focus on one end of linear flow t_{elf} and A\sqrt{k}, the start of boundary dominated flow t_{sbdf} and the drainage volume Vᵣ. These physical characteristics may be selected as they are more easily identifiable and are strongly driven by geological properties and development strategies. Hence, a machine learning model may be designed to predict these characteristics using features of geological properties and development strategies. FIG. 6 illustrates a neural network architecture 600 to predict the selected physical characteristics of the flow regimes. The choices of actual geological and development features may be based on the dataset chosen to train the machine learning algorithm and may or may not be generated from existing producing wells. In general, the machine learning model may include neural networks and/or ensemble-based models, such as random forest and gradient boosted tree models. The effectiveness of the proposed workflow depends upon the strong cause-effect relationship between the features and target responses. For example, A\sqrt{k} is determined by the combined effects of completion design, reservoir geo-mechanical properties and permeability, while Vᵣ is directly impacted by reservoir quality and well interference.

The second step of the two-step machine learning workflow involves predicting production forecasts through multi-segment DCA. The underlying intuition is that the physical characteristics identified in the first step are closely linked to DCA parameters. Consequently, a machine learning model may be generated to predict DCA parameters using these physical characteristics as features, as depicted in the machine learning model 700 of FIG. 7. The two-segment DCA model, described above, includes five decline parameters and, similar to the first step illustrated in FIG. 6, one or more of the response variables (decline parameters) may be automatically generated from the existing producing wells in the training dataset.

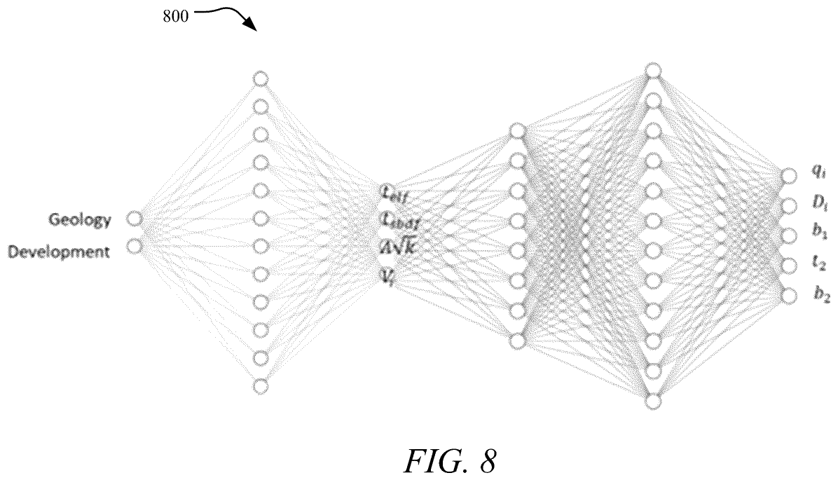

In some implementations, the two machine learning models (FIGS. 6 and 7) for each step are trained separately. In other implementations, however, both steps may be integrated into a single model, which would form an encoder-decoder type of architecture in neural networks, as illustrated in the machine learning workflow 800 of FIG. 8. The integration of the two aspects of the machine learning models may enhance the machine learning model's overall performance while reducing the time needed to obtain the model outputs.

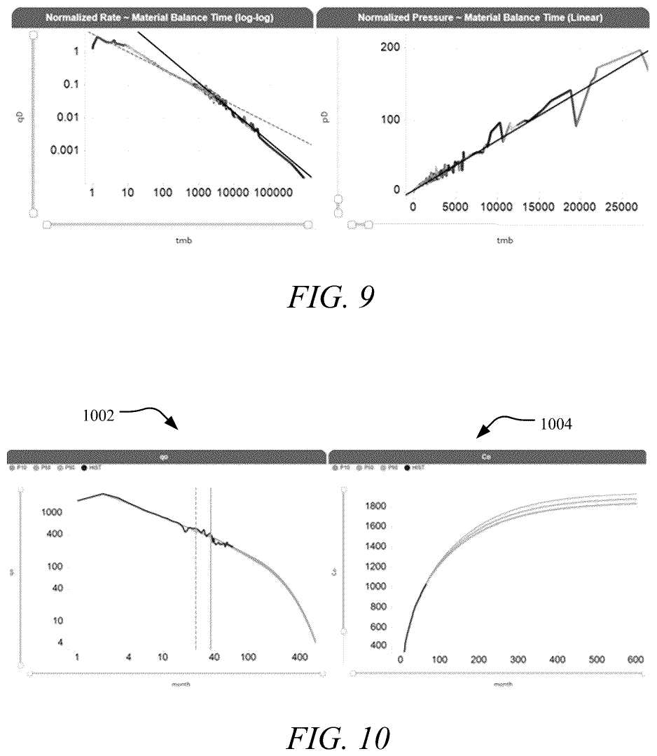

FIG. 9 illustrates automated flow regime analysis obtained from the machine learning models discussed above, in which the solid lines of the graphs represent the linear trend for BDF and the dashed line shows linear flow. The results are based on a limited use of production history of three years of a monitored well. Further, the start of the BDF is used in the DCA forecast as shown in the graphs of FIG. 10, which illustrates automated production forecast for oil rate (graph 1002) and oil cumulative production (graph 1004). In this figure, the solid line shows the end of the production history and dashed line shows the start of BDF. Even with a short time window of three years and noise in the data, the machine learning algorithm is able to generate the probabilistic forecasts, shown for the 10^{th}, 50^{th}, and 90^{th} quantiles in FIG. 10.

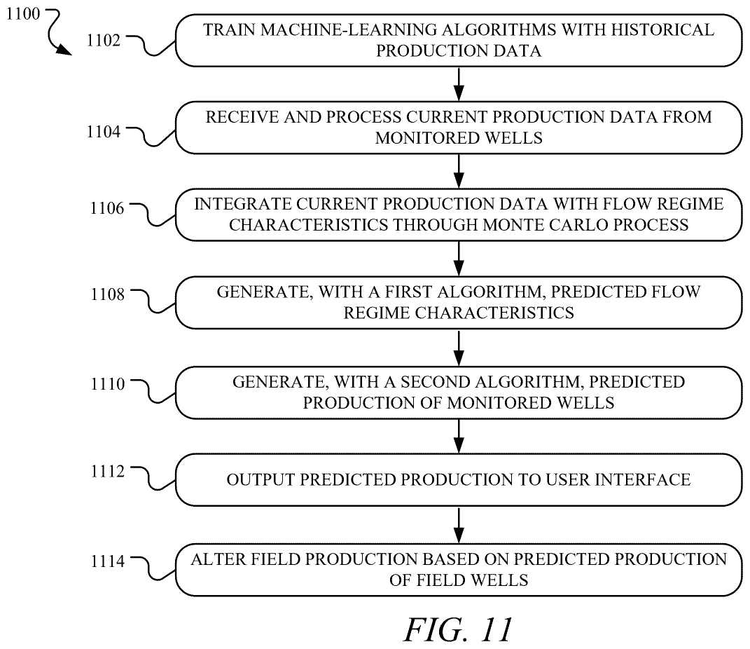

FIG. 11 illustrates example operations for utilizing a development optimization platform for production forecasting in unconventional reservoirs. The operations may be performed by a computing device configured to execute any operation or algorithm. Such operations may be executed through control of one or more hardware components, one or more software programs, or a combination of both hardware and software components of the computing device.

Beginning at operation 1102, one or more machine learning algorithms, such as those described above, may be trained on historical production data from one or more unconventional reservoirs. The training data for the machine learning algorithms may come from actual measurements or be automatically generated by auxiliary machine learning models. The training data selected may be based on the characteristics for which the algorithms are constructed to predict. For example, a machine learning model generated to predict the flow regimes and their characteristics may be trained on linear flow, the start of boundary dominated flow, and/or the drainage volume. In addition, at operation 1104, current production data may be received from one or monitored reservoirs. For example, production data from one or more monitored reservoirs may be received and analyzed. Such analysis may cause the generation of characteristic attributes for linear flow and boundary-dominated flow based on the received production data.

At operation 1106, the processed current production data, including the generated characteristic attributes of the data, may be integrated with flow regime analysis. In one implementation, the integration of the current production data with the flow regime analysis may be performed through a Markov chain Monte Carlo process, resulting in probabilistic multi-segment decline models for production forecasting with uncertainty ranges and confidence estimation. At operation 1108, a first machine learning algorithm, trained in operation 1102 above, may be executed to generate predicted flow regime characteristics for one or more unconventional reservoirs. Such an algorithm may operate as described above, with reference to FIG. 6, to generate characteristics of one end of linear flow t_{elf} and A\sqrt{k}, the start of boundary dominated flow t_{sbdf} and the drainage volume Vᵣ. However, the machine learning algorithm may be constructed to generate any flow regime characteristics using features of geological properties and development strategies.

At operation 1110, a second machine learning algorithm may be executed to receive the flow regime characteristics from the first machine learning algorithm and generate predicted production forecasts for the one or more unconventional reservoirs through multi-segment DCA, as the physical characteristics identified in the first step are closely linked to DCA parameters. The predicted production output of the second machine learning algorithm may be provided to a user interface at operation 1112 and, based on the predicted production of the one or more reservoirs, the operation of a reservoir field may be altered. For example, based on the predicted production of the reservoirs, operation at a well may be removed, increased, decreased, moved to another location, etc. In general, the operations of any of the wells of the field may be altered in response to the prediction production of the one or more reservoirs generated by the production forecasting platform 206 described herein.

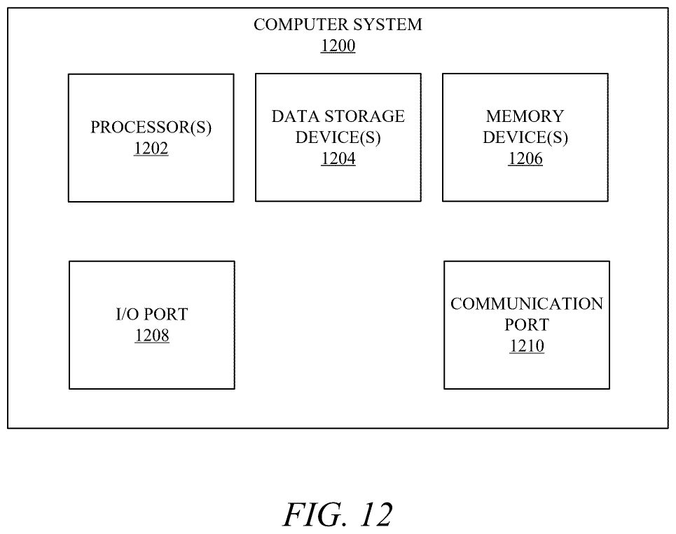

Referring now to FIG. 12, a detailed description of an example computing system 1200 having one or more computing units that may implement various systems and methods discussed herein is provided. The computing system 1200 may be applicable to the development optimization platform 102 of FIG. 1, the system 100, and other computing or network devices. It will be appreciated that specific implementations of these devices may be of differing possible specific computing architectures not all of which are specifically discussed herein but will be understood by those of ordinary skill in the art.

The computer system 1200 may be a computing system is capable of executing a computer program product to execute a computer process. Data and program files may be input to the computer system 1200, which reads the files and executes the programs therein. Some of the elements of the computer system 1200 are shown in FIG. 12, including one or more hardware processors 1202, one or more data storage devices 1204, one or more memory devices 1206, and/or one or more ports 1208-1210. Additionally, other elements that will be recognized by those skilled in the art may be included in the computing system 1200 but are not explicitly depicted in FIG. 12 or discussed further herein. Various elements of the computer system 1200 may communicate with one another by way of one or more communication buses, point-to-point communication paths, or other communication means not explicitly depicted in FIG. 12.

The processor 1202 may include, for example, a central processing unit (CPU), a microprocessor, a microcontroller, a digital signal processor (DSP), and/or one or more internal levels of cache. There may be one or more processors 1202, such that the processor 1202 comprises a single central-processing unit, or a plurality of processing units capable of executing instructions and performing operations in parallel with each other, commonly referred to as a parallel processing environment.

The computer system 1200 may be a conventional computer, a distributed computer, or any other type of computer, such as one or more external computers made available via a cloud computing architecture. The presently described technology is optionally implemented in software stored on the data stored device(s) 1204, stored on the memory device(s) 1206, and/or communicated via one or more of the ports 1208-1210, thereby transforming the computer system 1200 in FIG. 12 to a special purpose machine for implementing the operations described herein. Examples of the computer system 1200 include personal computers, terminals, workstations, mobile phones, tablets, laptops, personal computers, multimedia consoles, gaming consoles, set top boxes, and the like.

The one or more data storage devices 1204 may include any non-volatile data storage device capable of storing data generated or employed within the computing system 1200, such as computer executable instructions for performing a computer process, which may include instructions of both application programs and an operating system (OS) that manages the various components of the computing system 1200. The data storage devices 1204 may include, without limitation, magnetic disk drives, optical disk drives, solid state drives (SSDs), flash drives, and the like. The data storage devices 1204 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1206 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1204 and/or the memory devices 1206, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1200 includes one or more ports, such as an input/output (I/O) port 1208 and a communication port 1210, for communicating with other computing, network, or reservoir development devices. It will be appreciated that the ports 1208-1210 may be combined or separate and that more or fewer ports may be included in the computer system 1200.

The I/O port 1208 may be connected to an I/O device, or other device, by which information is input to or output from the computing system 1200. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1200 via the I/O port 1208. Similarly, the output devices may convert electrical signals received from computing system 1200 via the I/O port 1208 into signals that may be sensed as output by a human, such as sound, light, and/or touch. The input device may be an alphanumeric input device, including alphanumeric and other keys for communicating information and/or command selections to the processor 1202 via the I/O port 1208. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1200 via the I/O port 1208. For example, an electrical signal generated within the computing system 1200 may be converted to another type of signal, and/or vice-versa. In one implementation, the environment transducer devices sense characteristics or aspects of an environment local to or remote from the computing device 1200, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1200, such as, physical movement of some object (e.g., a mechanical actuator), heating or cooling of a substance, adding a chemical substance, and/or the like.

In one implementation, a communication port 1210 is connected to a network by way of which the computer system 1200 may receive network data useful in executing the methods and systems set out herein as well as transmitting information and network configuration changes determined thereby. Stated differently, the communication port 1210 connects the computer system 1200 to one or more communication interface devices configured to transmit and/or receive information between the computing system 1200 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1210 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 1210 may communicate with an antenna or other link for electromagnetic signal transmission and/or reception.

In an example implementation, waterflood model data, and software and other modules and services may be embodied by instructions stored on the data storage devices 904 and/or the memory devices 906 and executed by the processor 902. The computer system 900 may be integrated with or otherwise form part of the development optimization platform 102.

The system set forth in FIG. 9 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for optimizing production of a field, the method comprising:
receiving, using a processing device and from a plurality of databases, production data corresponding to one or more wells of the field;
generating, based on the received field data, a production forecast for the one or more wells of the field, wherein the production forecast is an output of a two-step machine learning process comprising:
a first machine learning process to predict, based on the received field data, predicted flow regime characteristics of the one or more wells of the field; and
a second machine learning process to receive the predicted flow regime characteristics as inputs and output the production forecast; and
generating, based on production forecast, a well development sequence for the field.

2. The method of claim 1, further comprising:
receiving historical production data of the one or more wells of the field; and training, utilizing the historical production data, the first machine learning process to predict the flow regime characteristics of the one or more wells of the field.

3. The method of claim 2, further comprising:
receiving historical flow regime characteristics of the one or more wells of the field; and training, utilizing the historical flow regime characteristics, the second machine learning process to generate the production forecast.

4. The method of claim 1, further comprising:
integrating the production data corresponding to one or more wells of the field with flow regime characteristics based on the production data corresponding to one or more wells of the field.

5. The method of claim 4, wherein the integration of the production data with the flow regime characteristics comprises a Monte Carlo process.

6. The method of claim 1, wherein the flow regime characteristics comprise at least one of a linear flow value, a start time of a boundary dominated flow, or a drainage volume.

7. The method of claim 1, wherein generating the production forecast further comprises conducting a decline curve analysis of the predicted flow regime characteristics.

8. The method of claim 1, further comprising:
displaying, in a user interface, the generated well development sequence for the field.

9. The method of claim 1, further comprising:
altering an operation of at least one of the one or more wells of the field in response to the generated well development sequence for the field.

10. A system comprising:
at least one well production measurement device; and
a production forecasting platform including an application to generate, by a two-step machine learning process and based on production data received from the at least one well production measurement device, a production forecast for a well, the two-step machine learning process comprising a first machine learning process to predict, based on the received field data, predicted flow regime characteristics of the one or more wells of the field and a second machine learning process to receive the predicted flow regime characteristics as inputs and output the production forecast.

11. The system of claim 10, wherein the product forecasting platform further receives historical production data of the one or more wells of the field; and training, utilizing the historical production data, the first machine learning process to predict the flow regime characteristics of the one or more wells of the field.

12. The system of claim 11, wherein the product forecasting platform further receives historical flow regime characteristics of the one or more wells of the field; and training, utilizing the historical flow regime characteristics, the second machine learning process to generate the production forecast.

13. The system of claim 10, wherein the product forecasting platform further integrates the production data corresponding to one or more wells of the field with flow regime characteristics based on the production data corresponding to one or more wells of the field.

14. The system of claim 13, wherein the integration of the production data with the flow regime characteristics comprises a Monte Carlo process.

15. The system of claim 10, wherein the flow regime characteristics comprise at least one of a linear flow value, a start time of a boundary dominated flow, or a drainage volume.

16. The system of claim 10, wherein generating the production forecast further comprises conducting a decline curve analysis of the predicted flow regime characteristics.

17. The system of claim 10, wherein the product forecasting platform further displays, in a user interface, the generated well development sequence for the field.

18. The system of claim 10, wherein the product forecasting platform further alters an operation of at least one of the one or more wells of the field in response to the generated well development sequence for the field.

19. One or more tangible non-transitory computer-readable storage media storing computer-executable instructions for performing a computer process on a computing system, the computer process comprising:
receiving, using a processing device and from a plurality of databases, production data corresponding to one or more wells of a field;
generating, based on the received field data, a production forecast for the one or more wells of the field, wherein the production forecast is an output of a two-step machine learning process comprising:
a first machine learning process to predict, based on the received field data, predicted flow regime characteristics of the one or more wells of the field; and
a second machine learning process to receive the predicted flow regime characteristics as inputs and output the production forecast; and
generating, based on production forecast, a well development sequence for the field.

20. The one or more tangible non-transitory computer-readable storage media of claim 19, wherein the computer process further comprises:
receiving historical production data of the one or more wells of the field; and training, utilizing the historical production data, the first machine learning process to predict the flow regime characteristics of the one or more wells of the field; and
receiving historical flow regime characteristics of the one or more wells of the field; and training, utilizing the historical flow regime characteristics, the second machine learning process to generate the production forecast.
